(19) United States
(12) Patent Application Publication
(10) Pub. No.: US 2025/0205876 A1
(43) Pub. Date: Jun. 26, 2025

(54) MOVING BODY AND EXPANSION/CONTRACTION LINEAR MOTION MECHANISM

(71) Applicant: SONY GROUP CORPORATION, TOKYO (JP)

(72) Inventors: YASUHISA KAMIKAWA, TOKYO (JP); ATSUSHI SUZUKI, TOKYO (JP); KATSUFUMI SUGIMOTO, TOKYO (JP)

(21) Appl. No.: 18/847,491

(22) PCT Filed: Mar. 6, 2023
(86) PCT No.: PCT/JP2023/008364

§ 371 Date: Sep. 16, 2024

(30) Foreign Application Priority Data
Mar. 24, 2022 (JP) 2022-047953

(51) Int. Cl. B25J 9/10; B25J 18/02; B25J 19/00

(52) U.S. Cl. CPC B25J 9/106; B25J 18/02; B25J 19/0075

(57) ABSTRACT

The present technology relates to a moving body and an expansion/contraction linear motion mechanism enabling the moving body that includes the expansion/contraction linear motion mechanism to be downsized.

A moving body includes an expansion/contraction linear motion mechanism that expands and contracts in a first direction. The expansion/contraction linear motion mechanism includes a first link, a second link, a plurality of sprockets that includes a drive sprocket arranged on the first link and that is arranged on a plane parallel to the first direction, and a chain that connects the sprockets to each other, both ends of the chain being connected to the second link. The first link and the second link at least partially overlap in a second direction perpendicular to the plane. As the drive sprocket is driven, the first link and the second link move in the first direction so as to approach or separate from each other. The present technology can be applied to, for example, a leg robot.

### TECHNICAL FIELD

The present technology relates to a moving body and an expansion/contraction linear motion mechanism, and more particularly to a moving body and an expansion/contraction linear motion mechanism that can be downsized.

### BACKGROUND ART

Conventionally, an expansion/contraction linear motion mechanism has been proposed in which a plurality of links extending in the vertical direction is arranged in the horizontal direction, the links are connected by a chain, and the links are slid in the vertical direction to expand/contract in the vertical direction (see, for example, Patent Document 1).

### CITATION LIST

### Patent Document

Patent Document 1: Japanese Patent Application Laid-Open No. 2006-43867

### SUMMARY OF THE INVENTION

### Problems to be Solved by the Invention

However, in the expansion/contraction linear motion mechanism described in Patent Document 1, since the plurality of links is simply arranged in the horizontal direction, the space occupied by the links becomes large, and the expansion/contraction linear motion mechanism becomes large.

The present technology has been made in view of such a situation, and can downsize an expansion/contraction linear motion mechanism. The present technology can further downsize a moving body including the expansion/contraction linear motion mechanism.

### Solutions to Problems

A moving body according to a first aspect of the present technology includes an expansion/contraction linear motion mechanism that expands and contracts in a first direction. The expansion/contraction linear motion mechanism includes a first link, a second link, a plurality of sprockets that includes a drive sprocket arranged on the first link and that is arranged on a plane parallel to the first direction, and a chain that connects the sprockets to each other, both ends of the chain being connected to the second link. The first link and the second link at least partially overlap in a second direction perpendicular to the plane. As the drive sprocket is driven, the first link and the second link move in the first direction so as to approach or separate from each other.

An expansion/contraction linear motion mechanism according to a second aspect of the present technology includes a first link, a second link, a plurality of sprockets that includes a drive sprocket arranged on the first link and that is arranged on a plane parallel to a first direction, and a chain that connects the sprockets to each other, both ends of the chain being connected to a first connecting portion of the second link. The first link and the second link at least partially overlap in a second direction perpendicular to the plane. As the drive sprocket is driven, the first link and the second link move in the first direction so as to approach or separate from each other.

In the first aspect or the second aspect of the present technology, the first link and the second link move in the first direction so as to approach or separate from each other.

### BRIEF DESCRIPTION OF DRAWINGS

FIG. 1 is a perspective view of a leg, to which the present technology is applied, in a most contracted state as viewed from the left front.

FIG. 2 is a perspective view illustrating a state in which a cover is removed from the leg in FIG. 1.

FIG. 3 is a perspective view of the leg, to which the present technology is applied, in the most contracted state as viewed from the left rear.

FIG. 4 is a perspective view illustrating a state in which the cover is removed from the leg in FIG. 3.

FIG. 5 is a perspective view of the leg, to which the present technology is applied, in a most expanded state as viewed from the left front.

FIG. 6 is a perspective view illustrating a state in which the cover is removed from the leg in FIG. 5.

FIG. 7 is a perspective view of the leg, to which the present technology is applied, in the most expanded state as viewed from the left rear.

FIG. 8 is a perspective view illustrating a state in which the cover is removed from the leg in FIG. 7.

FIG. 9 is a perspective view of the leg, to which the present technology is applied, in a moderately expanded state as viewed from the left front.

FIG. 10 is a perspective view illustrating a state in which the cover is removed from the leg in FIG. 9.

FIG. 11 is a perspective view of the leg, to which the present technology is applied, in the moderately expanded state as viewed from the left rear.

FIG. 12 is a perspective view illustrating a state in which the cover is removed from the leg in FIG. 11.

FIG. 13 is a cross-sectional view of the leg, to which the present technology is applied, in the most contracted state as viewed from the front.

FIG. 14 is a cross-sectional view of the leg, to which the present technology is applied, in the most contracted state as viewed from the rear.

FIG. 15 is a cross-sectional view of the leg, to which the present technology is applied, in the most contracted state as viewed from the left.

FIG. 16 is a cross-sectional view of the leg, to which the present technology is applied, in the most contracted state as viewed from the right.

FIG. 17 is a cross-sectional view of the leg, to which the present technology is applied, in the most expanded state as viewed from the left.

FIG. 18 is a cross-sectional view of the leg, to which the present technology is applied, as viewed from below.

FIG. 19 is a perspective view of a base link in a state where the cover is attached as viewed from the left front.

FIG. 20 is a perspective view of the base link in a state where the cover is removed as viewed from the left front.

FIG. 21 is a perspective view of an intermediate link as viewed from the slightly right side of the front.

FIG. 22 is a left side view of the intermediate link.

FIG. 23 is a right side view of the intermediate link.

FIG. 24 is a cross-sectional view of a tip end link as viewed from the left.

FIG. 25 is a perspective view of the tip end link as viewed from the left rear.

FIG. 26 is a schematic view illustrating a configuration example of a leg robot to which the present technology is applied.

FIG. 27 is a diagram for explaining an operation of the leg robot in FIG. 26.

FIG. 28 is a schematic view illustrating a configuration example of an arm robot to which the present technology is applied.

### MODE FOR CARRYING OUT THE INVENTION

Hereinafter, modes for carrying out the present technology will be described. The description will be given in the following order.
1. Embodiment
2. Application Examples
3. Modification Examples
4. Others

### 1. Embodiment

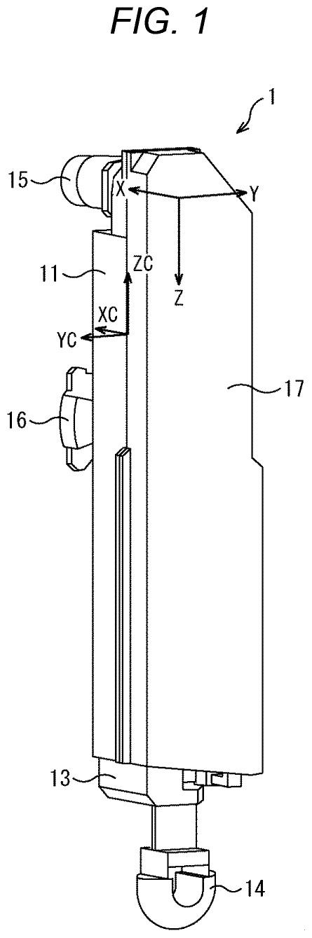

An embodiment of the present technology will be described with reference to FIGS. 1 to 25.

FIGS. 1 to 25 illustrate a configuration example of a leg 1 including an expansion/contraction linear motion mechanism to which the present technology is applied. The leg 1 is used, for example, for the left leg of a robot.

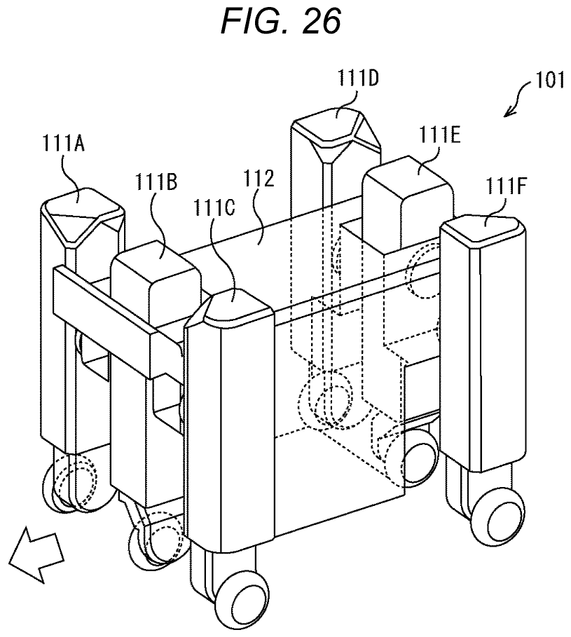

Note that, in FIG. 1 and the like, the X axis, the Y axis, and the Z axis indicate a coordinate system of the leg 1. The X axis indicates the right-left direction of the leg 1, and the right direction is the positive direction. The Y axis indicates the front-rear direction of the leg 1, and the rear direction is the positive direction. The Z axis indicates the up-down direction of the leg 1, and the downward direction is the positive direction. The XC axis, the YC axis, and the ZC axis indicate a coordinate system of a moving body (for example, a leg robot 101 in FIG. 26 to be described later) including the leg 1. The XC axis indicates the right-left direction of the moving body, and the right direction is the positive direction. The YC axis indicates the front-rear direction of the moving body, and the front direction is the positive direction, which is opposite to the case of the Y axis. The ZC axis indicates the up-down direction of the moving body, and the upward direction is the positive direction, which is opposite to the case of the Z axis.

Note that, hereinafter, the negative direction side of the Y axis of the leg 1 is referred to as the front side of the leg 1, and the positive direction side is referred to as the rear side of the leg 1. The negative direction side of the X axis of the leg 1 is referred to as the left side or the outer side of the leg 1, and the positive direction side is referred to as the right side or the inner side of the leg 1. The negative direction side of the Z axis of the leg 1 is referred to as the upper side of the leg 1, and the positive direction side is referred to as the lower side of the leg 1.

FIGS. 1 to 18 illustrate a configuration example of the leg 1 in an assembled state.

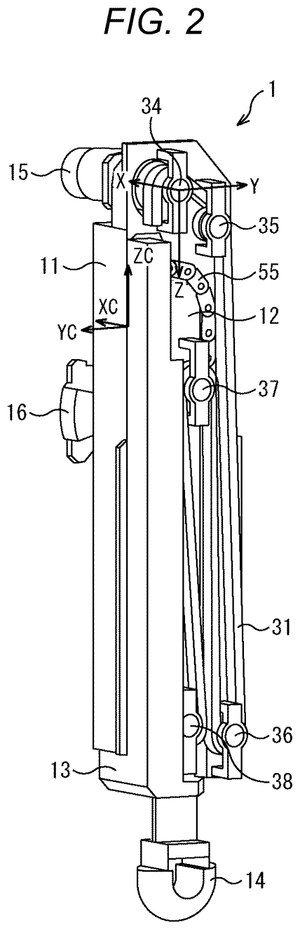

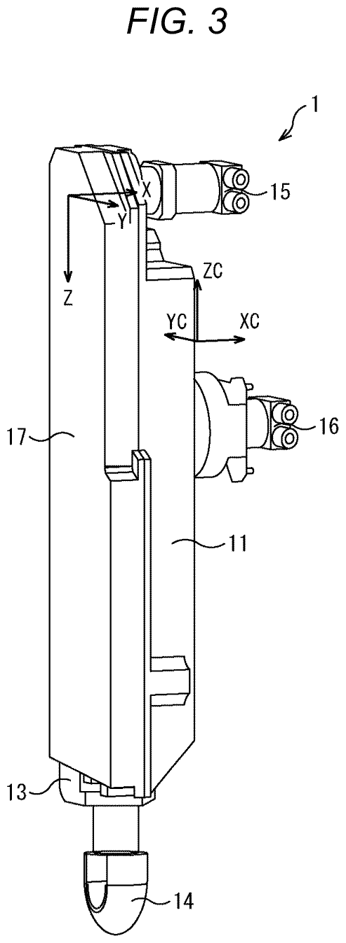

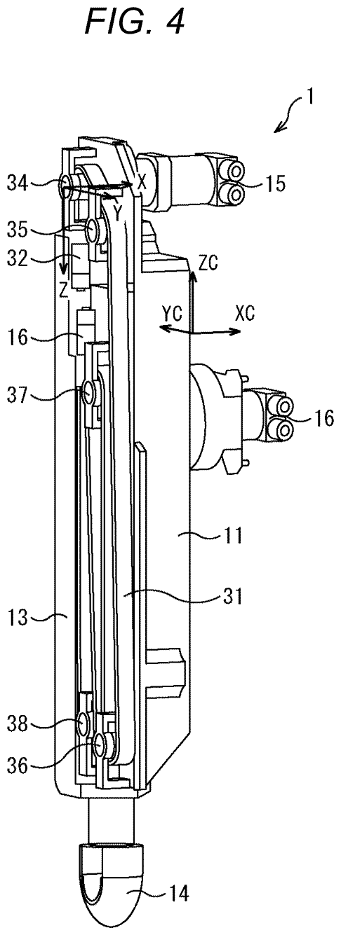

Specifically, FIG. 1 is a perspective view of the leg 1 in a most contracted state as viewed from the left front. FIG. 2 is a perspective view illustrating a state in which a cover 17 is removed from the leg 1 in FIG. 1. FIG. 3 is a perspective view of the leg 1 in the most contracted state as viewed from the left rear. FIG. 4 is a perspective view illustrating a state in which the cover 17 is removed from the leg 1 in FIG. 3.

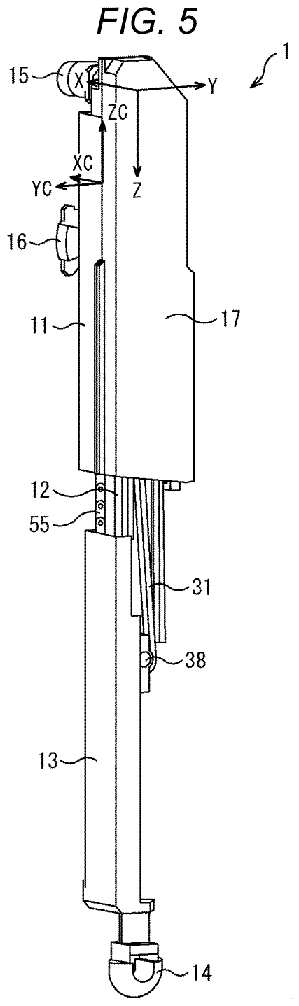

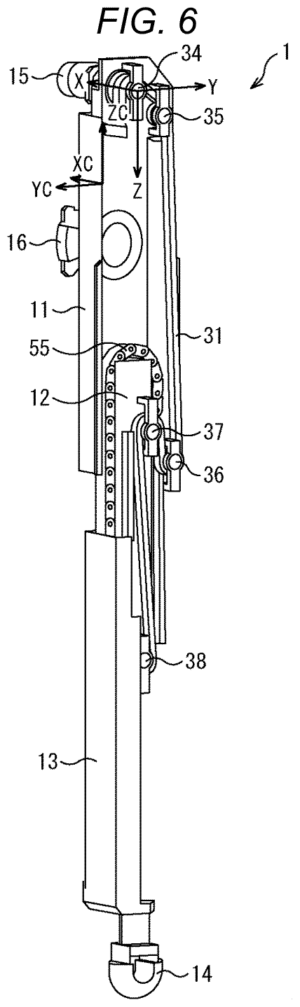

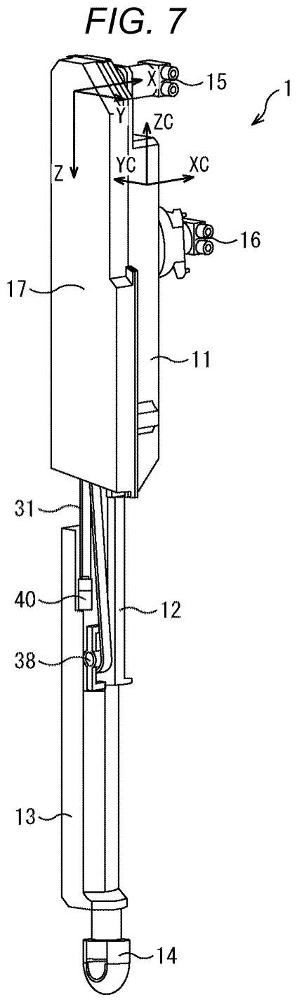

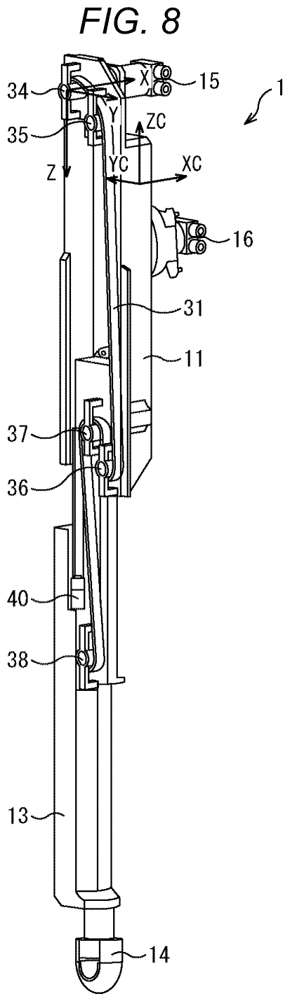

FIG. 5 is a perspective view of the leg 1 in a most expanded state as viewed from the left front. FIG. 6 is a perspective view illustrating a state in which the cover 17 is removed from the leg 1 in FIG. 5. FIG. 7 is a perspective view of the leg 1 in the most expanded state as viewed from the left rear. FIG. 8 is a perspective view illustrating a state in which the cover 17 is removed from the leg 1 in FIG. 7.

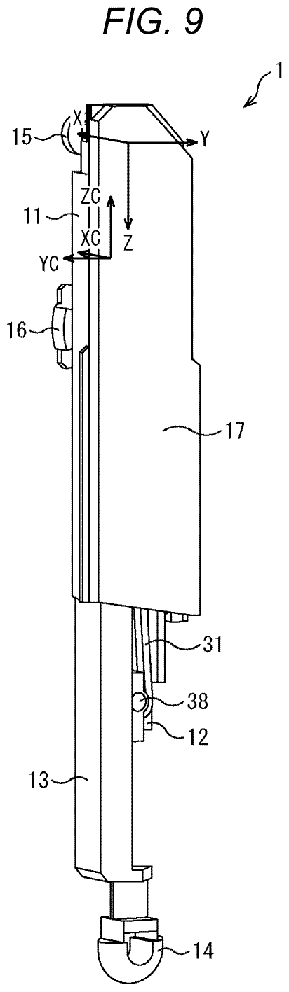

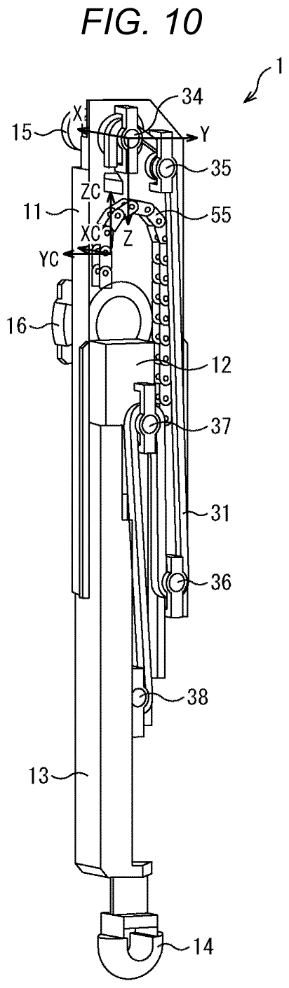

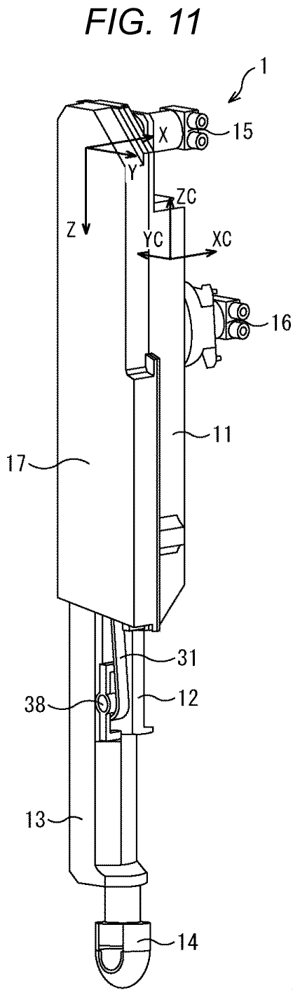

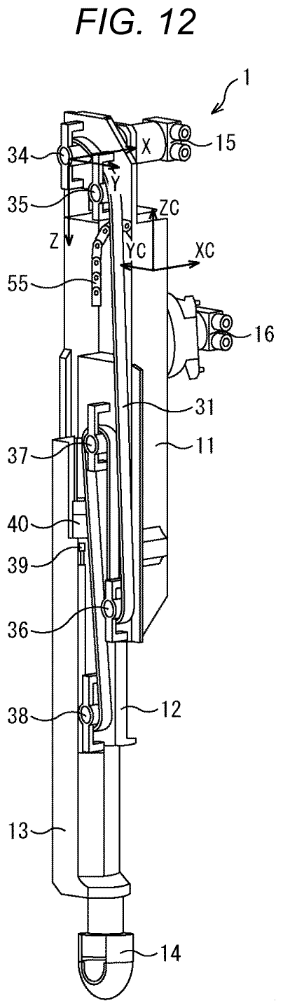

FIG. 9 is a perspective view of the leg 1 in a moderately expanded state as viewed from the left front. FIG. 10 is a perspective view illustrating a state in which the cover 17 is removed from the leg 1 in FIG. 9. FIG. 11 is a perspective view of the leg 1 in the moderately expanded state as viewed from the left rear. FIG. 12 is a perspective view illustrating a state in which the cover 17 is removed from the leg 1 in FIG. 11.

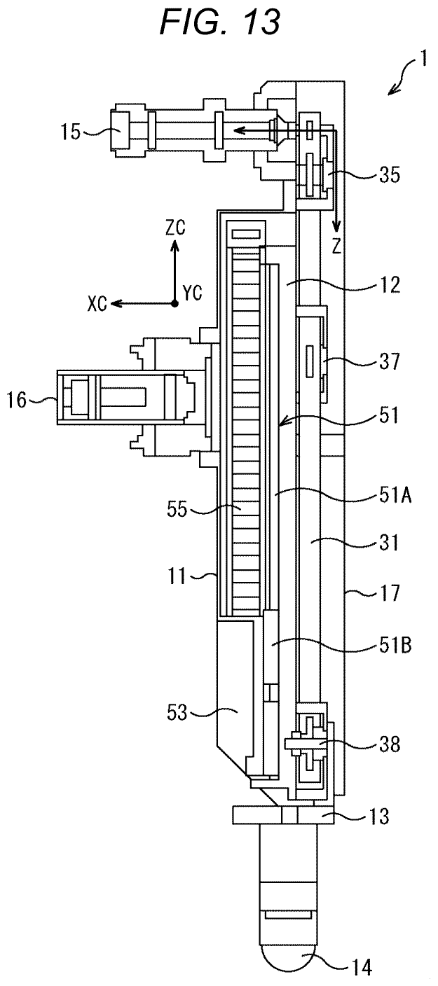

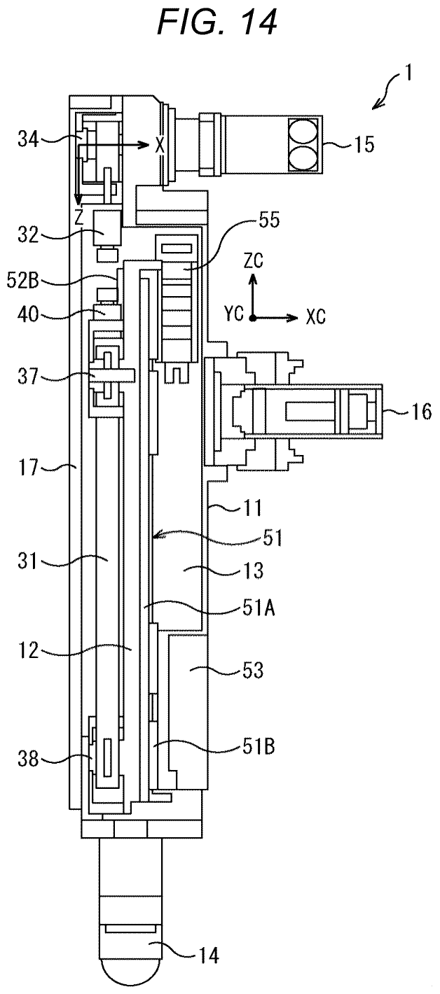

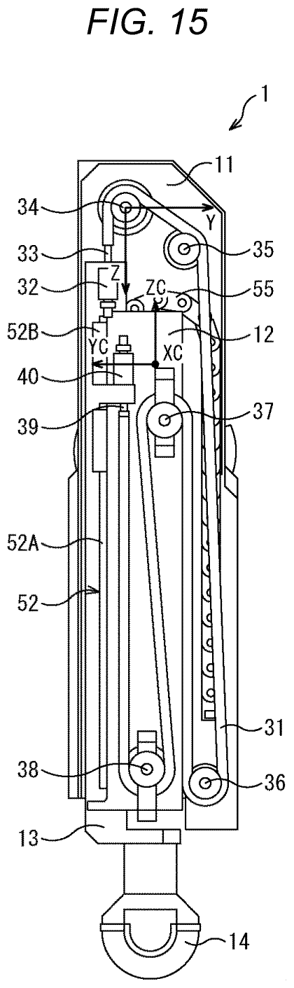

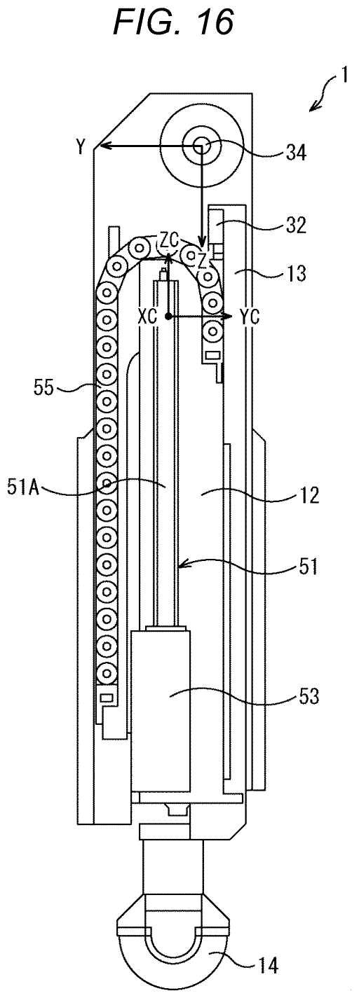

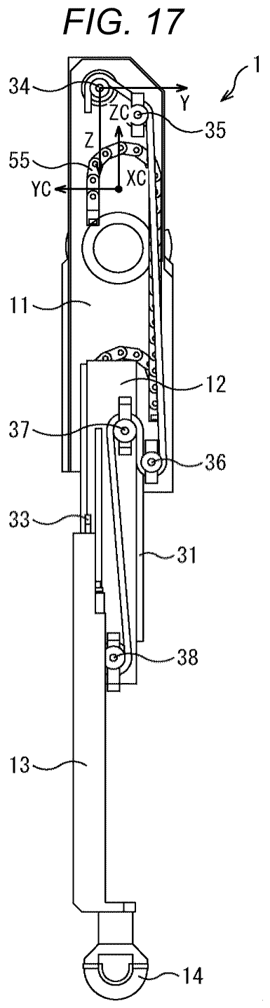

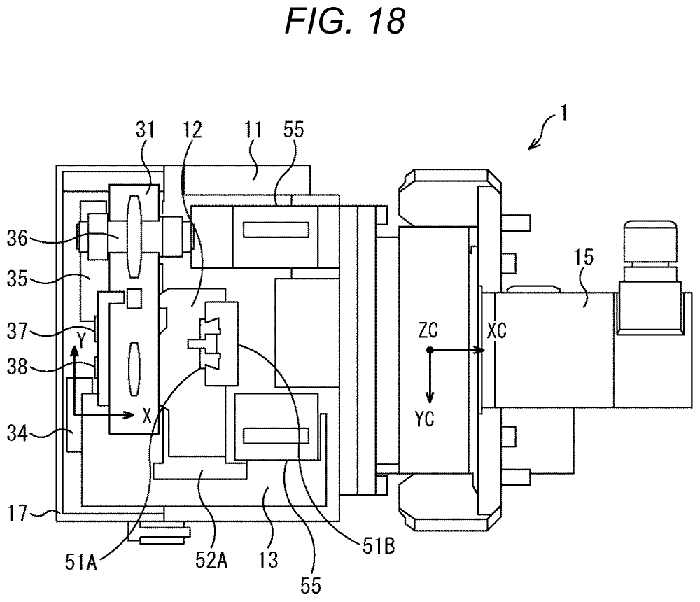

FIG. 13 is a cross-sectional view of the leg 1 in the most contracted state as viewed from the front. FIG. 14 is a cross-sectional view of the leg 1 in the most contracted state as viewed from the rear. FIG. 15 is a cross-sectional view of the leg 1 in the most contracted state as viewed from the left. FIG. 16 is a cross-sectional view of the leg 1 in the most contracted state as viewed from the right. FIG. 17 is a cross-sectional view of the leg 1 in the most expanded state as viewed from the left. FIG. 18 is a cross-sectional view of the leg 1 as viewed from below.

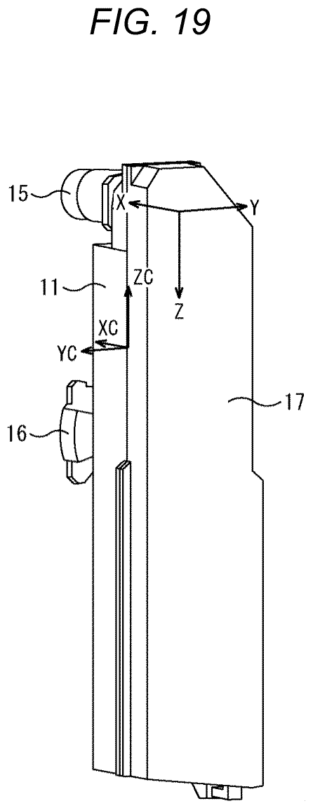

FIGS. 19 to 25 illustrate respective configurations of a base link 11, an intermediate link 12, and a tip end link 13, which are main components constituting the leg 1.

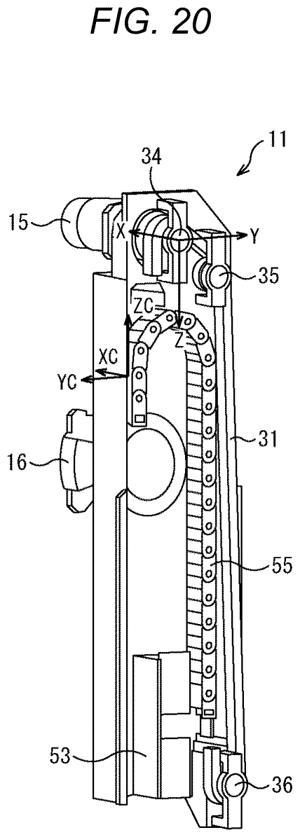

Specifically, FIG. 19 is a perspective view of the base link 11 in a state where the cover 17 is attached as viewed from the left front. FIG. 20 is a perspective view of the base link 11 in a state where the cover 17 is removed as viewed from the left front.

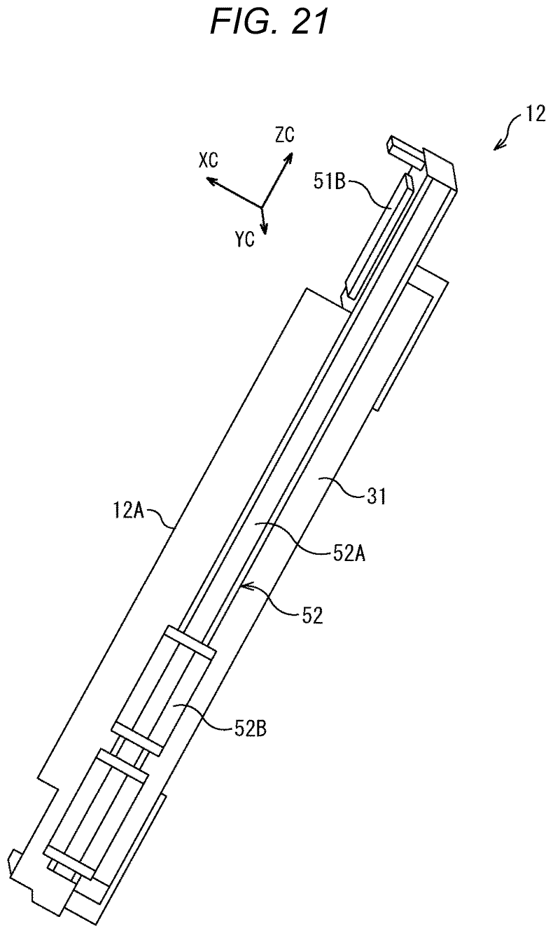

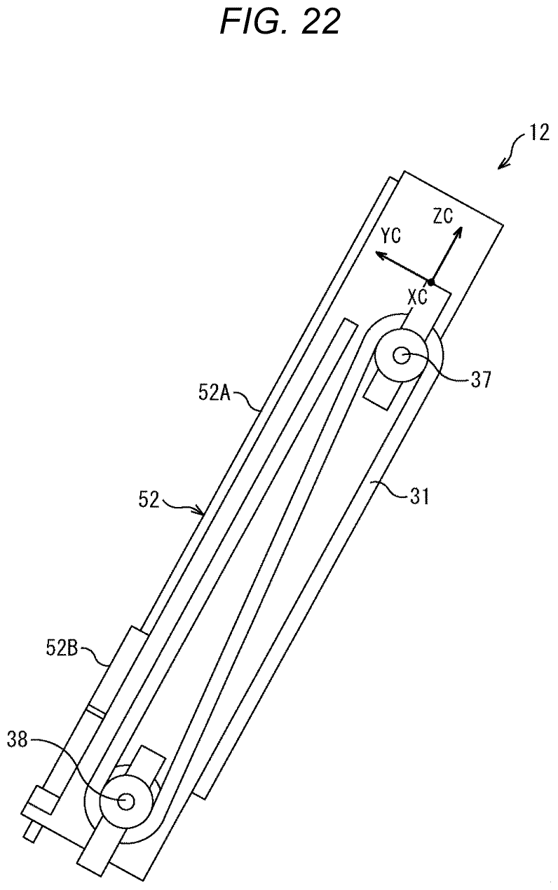

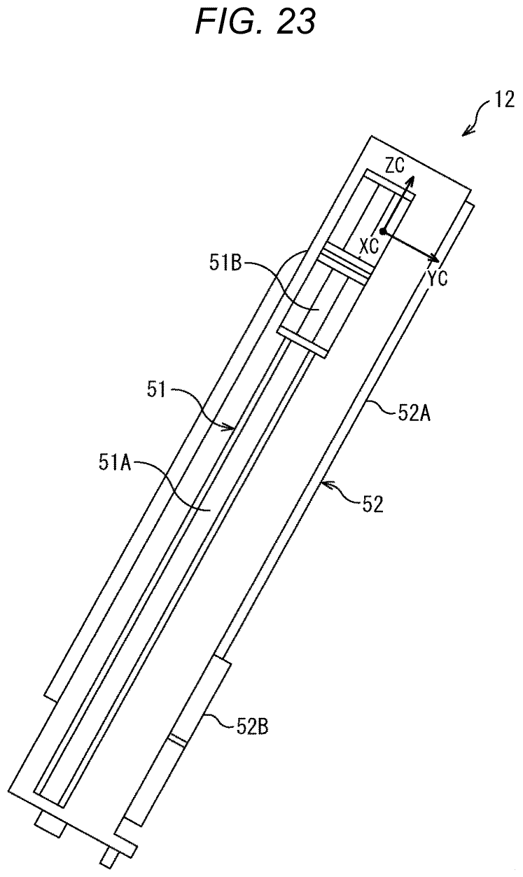

FIG. 21 is a perspective view of the intermediate link 12 as viewed from the slightly right side of the front. FIG. 22 is a left side view of the intermediate link 12. FIG. 23 is a right side view of the intermediate link 12.

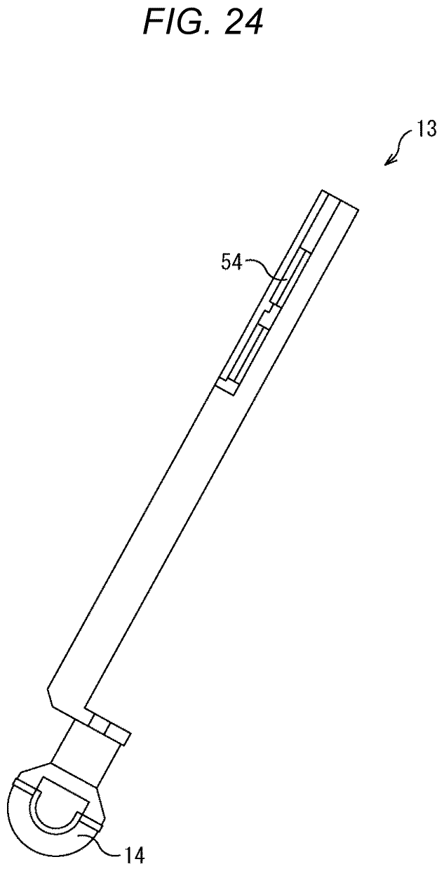

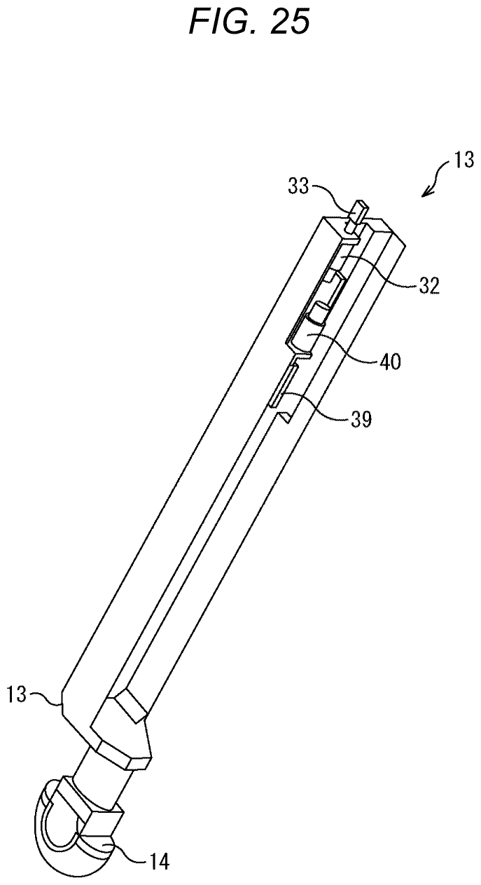

FIG. 24 is a cross-sectional view of the tip end link 13 as viewed from the left. FIG. 25 is a perspective view of the tip end link 13 as viewed from the left rear.

Note that, in FIGS. 1 to 25, illustration of some of the components is omitted as necessary to facilitate understanding of the drawings.

As illustrated in FIGS. 1, 2, and the like, the leg 1 includes the base link 11, the intermediate link 12, the tip end link 13, a caster 14, a motor 15, a hip joint 16, and the cover 17.

As illustrated in FIG. 15 and the like, the base link 11, the intermediate link 12, and the tip end link 13 are connected to each other via a chain 31. Also, as illustrated in FIGS. 1 to 12 and the like, the base link 11, the intermediate link 12, and the tip end link 13 move in the up-down direction so as to approach or separate from each other by means of the chain 31. Therefore, the leg 1 having a linear motion type two-stage expansion/contraction structure is achieved.

As illustrated in FIG. 20 and the like, the base link 11 is a member extending in the up-down direction. On the left side surface of the base link 11, a drive sprocket 34, a passive sprocket 35, a passive sprocket 36, a guide connection unit 53, and a cable carrier 55 are arranged. On the right side surface of the base link 11, which is the back side of the left side surface, the motor 15 and the hip joint 16 are connected.

The drive sprocket 34 is arranged near the upper end and the front end of the left side surface of the base link 11.

The motor 15 includes, for example, a dustproof and waterproof specification planetary gear-equipped motor. The motor 15 is arranged at a position corresponding to the drive sprocket 34 on the right side surface of the base link 11. The drive sprocket 34 is directly connected to the output shaft of the motor 15 and is driven by the motor 15.

The passive sprocket 35 is arranged slightly below the upper end and near the rear end of the left side surface of the base link 11. The passive sprocket 35 is arranged at a lower position than the drive sprocket 34.

The passive sprocket 36 is arranged near the lower end and the rear end of the left side surface of the base link 11. As illustrated in FIG. 15 and the like, the passive sprocket 36 is arranged slightly on the rear side of the passive sprocket 35.

Note that the passive sprocket 35 and the passive sprocket 36 are each supported by, for example, a bearing (not illustrated) with a contact-type seal having dustproof and waterproof specification.

The guide connection unit 53 includes, for example, a guide nut. The guide connection unit 53 is arranged at the lower end and near the center in the front-rear direction of the left side surface of the base link 11.

The hip joint 16 is arranged near the center of the right side surface of the base link 11 in the up-down direction and the front-rear direction.

On the left side surface of the base link 11, the cable carrier 55 is arranged in an inverted J shape obtained by vertically inverting the J shape between the vicinity of the position corresponding to the front end and the upper end of the hip joint 16 and the vicinity of the rear end slightly above the passive sprocket 36. Furthermore, as illustrated in FIG. 6 and the like, the cable carrier 55 is arranged in an inverted J shape obtained by vertically and horizontally inverting the J shape between the vicinity of the rear end slightly above the passive sprocket 36 on the left side surface of the base link 11 and the tip end link 13. The cable carrier 55 stores and protects cables extending from the hip joint 16.

As illustrated in FIGS. 21 to 23 and the like, the intermediate link 12 is a member extending in the up-down direction.

As illustrated in FIG. 21, on the front surface of the intermediate link 12, a linear guide 52 including a rail 52A and a guide unit 52B is provided. The linear guide 52 includes, for example, a dustproof and waterproof specification linear guide. The rail 52A is arranged so as to extend from the upper end substantially to the lower end of the front surface of the intermediate link 12. The guide unit 52B moves in the up-down direction along the rail 52A.

A guide connection unit 54 (FIG. 24), to be described later, of the tip end link 13 is attached to the guide unit 52B. Therefore, the tip end link 13 is guided by the linear guide 52 and moves in the up-down direction.

As illustrated in FIG. 22, on the left side surface of the intermediate link 12, a passive sprocket 37 and a passive sprocket 38 are arranged. The passive sprocket 37 is arranged slightly below the upper end and near the rear end of the left side surface of the intermediate link 12. The passive sprocket 38 is arranged at the lower end and near the center in the front-rear direction of the left side surface of the intermediate link 12.

Note that the passive sprocket 37 and the passive sprocket 38 are each supported by, for example, a bearing (not illustrated) with a contact-type seal having dustproof and waterproof specification.

As illustrated in FIG. 23, on the right side surface of the intermediate link 12, a linear guide 51 including a rail 51A and a guide unit 51B is provided. The linear guide 51 includes, for example, a dustproof and waterproof specification linear guide similarly to the linear guide 52. The rail 51A is arranged on the rear side on the left side surface of the intermediate link 12 so as to extend substantially from the upper end substantially to the lower end. The guide unit 51B moves in the up-down direction along the rail 51A.

To the guide unit 51B is attached the guide connection unit 53, described above, of the base link 11. Therefore, the base link 11 is guided by the linear guide 51 and moves in the up-down direction.

Furthermore, as illustrated in FIG. 21, on the right side surface of the intermediate link 12, a rib 12A higher than the upper end of the linear guide 51 is formed.

As illustrated in FIGS. 24, 25, and the like, the tip end link 13 is a member extending in the up-down direction. The tip end link 13 includes a left side surface and a right side surface opposed to each other, and a side surface in which a front surface perpendicular to the left side surface and the right side surface is arranged in a U shape (horseshoe shape). The back side of the side surface of the tip end link 13 is open.

As illustrated in FIG. 24, the guide connection unit 54 is arranged slightly below the upper end and substantially around the center in the right-left direction on the surface on the back side of the front surface of the tip end link 13. As described above, the guide connection unit 54 is attached to the guide unit 52B of the linear guide 52 arranged on the surface of the intermediate link 12 opposed to the surface on the back side of the front surface of the tip end link 13.

As illustrated in FIGS. 15, 25, and the like, a spring 32 is arranged near the upper end and the left end of the tip end link 13. The lower end of the spring 32 is connected to and fixed to the tip end link 13. The upper end of the spring 32 is connected to a chain fastening unit 33, and the chain fastening unit 33 protrudes from the upper surface of the tip end link 13.

As illustrated in FIGS. 15, 25, and the like, a spring 40 is arranged slightly on the rear side and slightly on the lower side of the spring 32 in the tip end link 13. The upper end of the spring 40 is connected to and fixed to the tip end link 13. The lower end of the spring 40 is connected to a chain fastening unit 39.

As illustrated in FIGS. 24, 25, and the like, on the lower surface of the tip end link 13, the caster 14 is provided.

As illustrated in FIG. 15 and the like, in a state where the base link 11, the intermediate link 12, and the tip end link 13 are combined and the leg 1 is contracted the most, the intermediate link 12 and the tip end link 13 are housed in a space formed by the left side surface of the base link 11 and the cover 17 that covers the left side surface of the base link 11.

As illustrated in FIGS. 15, 18, and the like, the front end portion of the intermediate link 12 is sandwiched between the left side surface and the right side surface of the tip end link 13. With this arrangement, the intermediate link 12 and the tip end link 13 at least partially overlap in the right-left direction. Also, the guide connection unit 54 on the surface on the back side of the front surface of the tip end link 13 is attached to the guide unit 52B of the linear guide 52 on the front surface of the intermediate link 12.

As illustrated in FIG. 15 and the like, the spring 32, the chain fastening unit 33, the drive sprocket 34, the passive sprocket 35 to the passive sprocket 38, the chain fastening unit 39, and the spring 40 are arranged on the same plane (hereinafter, referred to as a chain arrangement surface) parallel to the left side surface of the base link 11. The chain arrangement surface is a surface parallel to the expansion/contraction direction of the leg 1. The chain fastening unit 39 and the spring 40 overlap with the intermediate link 12 in a direction perpendicular to the chain arrangement surface (the direction is the right-left direction).

As illustrated in FIGS. 13, 14, 16, 18, and the like, the linear guide 51 and the cable carrier 55 are arranged between the left side surface of the base link 11 and the right side surface of the intermediate link 12 opposed to each other. The cable carrier 55 is arranged to surround a part of the periphery of the linear guide 51 so as not to interfere with the linear guide 51 of the intermediate link 12.

As illustrated in FIGS. 15, 18, and the like, the linear guide 52 is arranged between the front surface of the intermediate link 12 and the surface on the back side of the front surface of the tip end link 13.

In this manner, the chain arrangement surface is opened without the linear guide 51, the linear guide 52, the cable carrier 55, and the like interfering with the chain arrangement surface. Therefore, the flexibility of the arrangement of the chain 31 is added, and for example, the number of sprockets can be reduced.

In addition, the base link 11, the intermediate link 12, and the tip end link 13 overlap in a direction perpendicular to the chain arrangement surface (the direction is the right-left direction). In addition, the linear guide 51 and the cable carrier 55 overlap in the direction perpendicular to the chain arrangement surface. With this arrangement, the leg 1 can be downsized.

Furthermore, by covering the left side surface of the base link 11 opened to the chain arrangement surface side with the cover 17 having strength after the arrangement of the chain 31, the strength can be improved without increasing the size of the base link 11.

Meanwhile, in a case where the leg 1 is downsized, the intermediate link 12 becomes thin and is easy to be deformed by the tensile force of the chain 31. To deal with this, by forming the rib 12A on the right side surface of the intermediate link 12, the deformation of the intermediate link 12 can be prevented without the need for increasing the volume of the leg 1.

Moreover, the structure of the connecting portion between the guide connection unit 53 of the base link 11 and the linear guide 51 of the intermediate link 12 and the structure of the connecting portion between the guide connection unit 54 of the tip end link 13 and the linear guide 52 of the intermediate link 12 are simple. With this arrangement, the leg 1 can be downsized.

In addition, for example, in a robot using the leg 1, the most severe load condition is a load applied in an oblique direction of the traveling direction. To deal with this, the linear guide 52 of the intermediate link 12 and the guide connection unit 54 of the tip end link 13 are arranged so as to overlap with each other in the front-rear direction. With this arrangement, the robot can receive the load applied in the oblique direction of the traveling direction without the tip end link 13 twisted.

As illustrated in FIG. 15 and the like, in a state where the leg 1 is contracted the most, the drive sprocket 34 is arranged near the upper end and the front end of the leg 1. The spring 32 is arranged slightly below the drive sprocket 34 near the front end of the leg 1. The passive sprocket 35 is arranged slightly below the drive sprocket 34 near the rear end of the leg 1. The passive sprocket 36 is arranged near the lower end and the rear end of the leg 1, and is arranged slightly on the rear side of the passive sprocket 35. The passive sprocket 37 is arranged slightly above the center of the leg 1. The passive sprocket 38 is arranged slightly on the front side of the passive sprocket 37 near the lower end of the leg 1. The spring 40 is arranged slightly below and slightly on the rear side of the spring 32.

The chain 31 includes, for example, a seal chain.

One end of the chain 31 extending from the direction of the tip end link 13 is connected to the spring 32 via the chain fastening unit 33. Therefore, one end of the chain 31 is connected to the tip end link 13 via the chain fastening unit 33 and the spring 32. The other end of the chain 31 extending from the direction of the intermediate link 12 is connected to the spring 40 via the chain fastening unit 39. Therefore, the other end of the chain 31 is connected to the tip end link 13 via the chain fastening unit 39 and the spring 40.

The chain 31 connects the drive sprocket 34, the passive sprocket 35, the passive sprocket 36, the passive sprocket 37, and the passive sprocket 38 in this order between the spring 32 and the spring 40.

For example, as illustrated in FIG. 15 and the like, in a state where the leg 1 is contracted the most, the chain 31 extends upward from the chain fastening unit 33 and is turned rearward and obliquely downward by the drive sprocket 34. Also, the chain 31 is turned downward and slightly rearward by the passive sprocket 35. Further, the chain 31 is turned upward by the passive sprocket 36. Further, the chain 31 is turned downward and slightly rearward by the passive sprocket 37. Further, the chain 31 is turned upward by the passive sprocket 37 and connected to the chain fastening unit 39. That is, the chain 31 is arranged in a meandering manner in the up-down direction between the passive sprocket 35 and the chain fastening unit 39.

Then, as the drive sprocket 34 is rotated in the front direction by the motor 15, the springs 32 and 40 connected to both ends of the chain 31 move downward. As the spring 32 and the spring 40 move downward, the tip end link 13 to which the spring 32 and the spring 40 are fixed moves in a direction away from the base link 11 (downward). As the tip end link 13 moves downward with respect to the base link 11, the passive sprocket 37 is pulled by the chain 31 and moves downward. As the passive sprocket 37 moves downward, the intermediate link 12 to which the passive sprocket 37 is fixed moves in a direction away from the base link 11 (downward).

As a result, as illustrated in FIG. 17 and the like, the distance in the up-down direction among the base link 11, the intermediate link 12, and the tip end link 13 increases, and the leg 1 expands in the up-down direction.

On the other hand, as the drive sprocket 34 is rotated in the rearward direction by the motor 15, the springs 32 and 40 connected to both ends of the chain 31 move upward. As the spring 32 and the spring 40 move upward, the tip end link 13 to which the spring 32 and the spring 40 are fixed moves in a direction approaching the base link 11 (upward). As the tip end link 13 moves upward with respect to the base link 11, the passive sprocket 38 is pulled by the chain 31 and moves upward. As the passive sprocket 38 moves upward, the intermediate link 12 to which the passive sprocket 38 is fixed moves in a direction approaching the base link 11 (upward).

As a result, as illustrated in FIG. 15 and the like, the distance in the up-down direction among the base link 11, the intermediate link 12, and the tip end link 13 decreases, and the leg 1 contracts in the up-down direction.

The spring 32 and the spring 40 are used for pre-tensioning (applying tension previously) of the chain 31 to prevent loosening of the chain 31.

In addition, since the chain 31 extending from the tip end link 13 is connected to the intermediate link 12 via the spring 40 for pre-tensioning, the impact when the tip end portion of the leg 1 collides with an outside object in the direction in which the leg 1 expands is absorbed by the spring 40. Furthermore, the maximum spring force of the spring 40 is set to be equal to or higher than the maximum load generated in the chain fastening unit 39 which is a connecting portion with the chain 31. This facilitates protection of the drive system from an impact due to collision. For example, in a case where the leg 1 is used for the leg of a robot, the drive system of the robot can be protected from an impact applied when the tip of the leg collides with the ground (for example, at the time of landing).

Also, since the chain 31 extending from the base link 11 is connected to the intermediate link 12 via the spring 32 for pre-tensioning, the impact when the tip end portion of the leg 1 collides with an outside object in the direction in which the leg 1 contracts is absorbed by the spring 32. Furthermore, the maximum spring force of the spring 32 is set to be equal to or higher than the maximum load generated in the chain fastening unit 33 which is a connecting portion with the chain 31. This facilitates protection of the drive system of the leg 1 from an impact due to collision. For example, in a case where a similar expansion/contraction linear motion mechanism to the leg 1 is used in an arm robot, the drive system of the robot can be protected from an impact applied when the arm robot lifts a heavy object.

In addition, in a case where the leg 1 is used for the leg of a robot, the maximum load when the leg 1 expands is higher than the maximum load when the leg 1 contracts. For this reason, the deformation amount of the spring 40 from the time of pre-tensioning when the maximum load is applied is set to be larger than the deformation amount of the spring 32 from the time of pre-tensioning when the maximum load is generated. That is, the spring constant of the spring 40 is set to be higher than the spring constant of the spring 32.

This makes it possible to set the pre-tensioning of the spring 40 to a minimum in consideration of the change over time at the moment when a large load is applied when the leg 1 expands, and the frictional force of the entire drive mechanism of the chain 31 is reduced and the mechanical loss is reduced.

Also, it is usually difficult to achieve dustproof and waterproof specification without covering the housing in a multi-stage linear motion mechanism.

To deal with this, a seal chain is used for the chain 31. A dustproof and waterproof specification planetary gear-equipped motor is used for the motor 15, and the output shaft of the motor 15 is directly connected to the drive sprocket 34. The passive sprocket 35 to the passive sprocket 38 are each supported by a bearing with a contact-type seal. Dustproof and waterproof specification linear guides are used for the linear guide 51 and the linear guide 52. This makes it possible to achieve dustproof and waterproof specification without covering the housing of the leg 1.

### 2. Application Examples

Next, application examples of the expansion/contraction linear motion mechanism to which the present technology is applied will be described with reference to FIGS. 26 to 28.

### <Configuration Example of Leg Robot 101>

FIG. 26 is a perspective view illustrating a configuration example of a leg robot 101 using the expansion linear motion mechanism to which the present technology is applied. Note that the direction indicated by the arrow in FIG. 26 is the front direction of the leg robot 101.

The leg robot 101 includes legs 111A to 111F and a body 112.

The leg 111A is connected to the obliquely right front of the body 112. The leg 111B is connected to the front and center of the body 112. The leg 111C is connected to the obliquely left front of the body 112. The leg 111D is connected to the obliquely right rear of the body 112. The leg 111E is connected to the rear and center of the body 112. The leg 111F is connected to the obliquely left rear of the body 112.

Note that, hereinafter, the legs 111A to 111F are simply referred to as the legs 111 in a case where it is not necessary to individually distinguish them from each other.

For each leg 111, the leg 1 described above or a leg including a similar expansion/contraction linear motion mechanism to the leg 1 is used. For the joint portion connecting each leg 111 to the body 112, the hip joint 16 described above or a similar joint mechanism to the hip joint 16 is used. For the knee joint of each leg 111, the expansion/contraction linear motion mechanism described above is used.

With this arrangement, the leg robot 101 can be downsized and the height can be kept low.

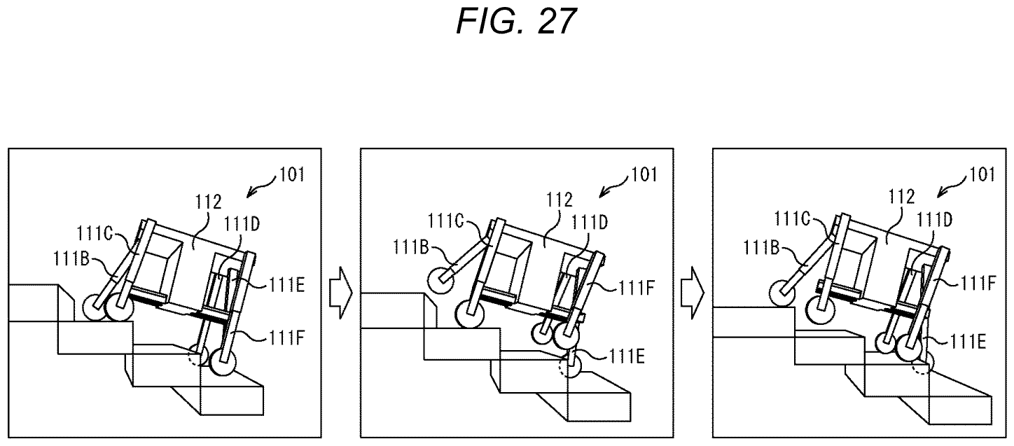

For example, as illustrated in FIG. 27, the leg robot 101 can go up and down the stairs by changing the inclination of each leg 111 with respect to the body 112 or expanding and contracting each leg 111. Here, since the leg robot 101 has shorter legs 111 than a leg robot including a leg whose joint bends in the front-back direction, the possibility that the leg 111 may interfere with the stairs is reduced.

### <Configuration Example of Arm Robot 151>

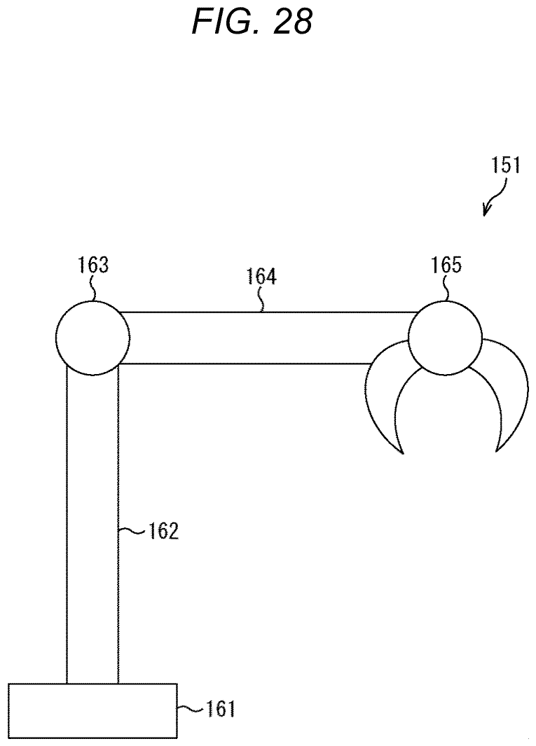

FIG. 28 is a schematic view illustrating a configuration example of an arm robot 151 using the expansion linear motion mechanism to which the present technology is applied.

The arm robot 151 includes a rotation shaft 161, an expansion/contraction linear motion mechanism 162, a connection unit 163, an expansion/contraction linear motion mechanism 164, and a gripper 165.

The expansion/contraction linear motion mechanism 162 is connected to the rotation shaft 161. The expansion/contraction linear motion mechanism 162 is connected to the expansion/contraction linear motion mechanism 164 via the connection unit 163. The gripper 165 is an end effector of the arm robot 151, and is connected to the tip end of the expansion/contraction linear motion mechanism 164.

The expansion/contraction linear motion mechanism 162 can be rotated about the longitudinal direction of the expansion/contraction linear motion mechanism 162 by the rotation shaft 161.

The height of the gripper 165 can be changed by the expansion/contraction linear motion mechanism 162. In addition, the distance of the gripper 165 from the connection unit 163 can be changed by the expansion/contraction linear motion mechanism 164.

With this arrangement, the arm robot 151 can be downsized. In addition, for example, in a state where the expansion/contraction linear motion mechanism 162 and the expansion/contraction linear motion mechanism 164 are contracted, the footprint of the arm robot 151 can be kept small, and the gripper 165 can be positioned while reducing the possibility of interference with an outside object.

### 3. Modification Examples

Next, modification examples of the above-described embodiment will be described.

For example, some of the sprockets may be arranged on the tip end link 13 as necessary.

The present technology can also be applied to a linear motion mechanism having a one-stage expansion/contraction structure with two links and a linear motion mechanism having a three-or-more-stage expansion/contraction structure with four or more links.

The present technology can be applied to a moving body using an expansion/contraction linear motion mechanism other than the leg robot 101 and the arm robot 151 described above.

### 4. Others

An embodiment of the present technology is not limited to the embodiment described above, and various modifications can be made without departing from the scope of the present technology.

For example, the present technology can also have the following configurations.

(1)

A moving body including:
an expansion/contraction linear motion mechanism that expands and contracts in a first direction,
in which the expansion/contraction linear motion mechanism includes
a first link,
a second link,
a plurality of sprockets that includes a drive sprocket arranged on the first link and that is arranged on a plane parallel to the first direction, and
a chain that connects the sprockets to each other, both ends of the chain being connected to the second link,
the first link and the second link at least partially overlap in a second direction perpendicular to the plane, and
as the drive sprocket is driven, the first link and the second link move in the first direction so as to approach or separate from each other.
   (2)

The moving body according to (1) described above,
in which the expansion/contraction linear motion mechanism further includes
a third link,
at least a part of a plurality of the sprockets is arranged on the first link and the third link,
at least a part of the third link overlaps with the first link and the second link in the second direction, and
as the drive sprocket is driven, the first link and the third link move in the first direction so as to approach or separate from each other.
   (3)

The moving body according to (2) described above,
in which, as for side surfaces of the second link, a first side surface and a second side surface parallel to the plane and opposed to each other, and a third side surface perpendicular to the first side surface and the second side surface and parallel to the first direction are arranged in a U shape, and
a part of the third link is sandwiched between the first side surface and the second side surface of the second link.
   (4)

The moving body according to (3) described above,
in which the second link and the third link are at least partially housed in a space formed by the first link and a cover that covers a surface of the first link on which the sprocket is arranged.
   (5)

The moving body according to (4) described above,
in which the first side surface of the second link is opposed to the first link, and
a cable carrier that houses a cable is arranged between the first link and the first side surface of the second link.
   (6)

The moving body according to (5) described above, further including:
a joint portion that is connected to the first link,
in which the cable carrier houses cables that extend from the joint portion.
   (7)

The moving body according to any one of (3) to (6) described above,
in which a linear guide that guides movement of the second link in the first direction is arranged on a surface of the third link opposed to the third side surface of the second link.
   (8)

The moving body according to (7) described above,
in which the linear guide has dustproof and waterproof specification.
   (9)

The moving body according to any one of (2) to (8) described above,
in which a portion where the chain is connected to the second link overlaps with the third link in the first direction.
   (10)

The moving body according to any one of (2) to (9) described above,
in which a linear guide that guides movement of the first link in the first direction is arranged on a first surface on the plane side and a second surface on a back side of the third link.
   (11)

The moving body according to (10) described above,
in which the second surface of the third link is provided with a rib that is higher than an upper end of the linear guide.
   (12)

The moving body according to (10) or (11) described above,
in which the linear guide has dustproof and waterproof specification.
   (13)

The moving body according to any one of (2) to (12) described above,
in which one end of the chain extends from the first link in a direction of the second link and is connected to the second link via a first spring, and
another end of the chain extends from the third link in a direction of the second link and is connected to the second link via a second spring.
   (14)

The moving body according to (13) described above,
in which a maximum spring force of the first spring is equal to or higher than a maximum load generated at a connecting portion with the chain, and
a maximum spring force of the second spring is equal to or higher than a maximum load generated at a connecting portion with the chain.
   (15)

The moving body according to (13) or (14) described above,
in which the expansion/contraction linear motion mechanism is used for a leg,
the first link is arranged at a base of the leg,
the second link is arranged at a tip end of the leg,
the third link is arranged between the base and the tip end of the leg, and
a spring constant of the second spring is higher than a spring constant of the first spring.
   (16)

The moving body according to any one of (1) to (15) described above, further including:
a motor that drives the drive sprocket.
   (17)

The moving body according to (16) described above,
in which the motor is a dustproof and waterproof specification planetary gear-equipped motor,
the drive sprocket is directly connected to an output shaft of the motor,
a passive sprocket of a plurality of the sprockets is supported by a bearing with a contact-type seal, and
the chain is a seal chain.
   (18)

An expansion/contraction linear motion mechanism including:
a first link;
a second link;
a plurality of sprockets that includes a drive sprocket arranged on the first link and that is arranged on a plane parallel to a first direction; and
a chain that connects the sprockets to each other, both ends of the chain being connected to a first connecting portion of the second link,
in which the first link and the second link at least partially overlap in a second direction perpendicular to the plane, and
as the drive sprocket is driven, the first link and the second link move in the first direction so as to approach or separate from each other.

Note that the effects described in the present specification are merely examples and are not limited, and other effects may be achieved.

### REFERENCE SIGNS LIST

1 Expansion/contraction linear motion mechanism
11 Base link
12 Intermediate link
13 Tip end link
14 Caster
15 Motor
16 Hip joint
17 Cover
31 Chain
32 Spring
33 Chain fastening unit
34 Drive sprocket
35 to 38 Passive sprocket
39 Chain fastening unit
40 Spring
51 Linear guide
51A Rail
51B Guide unit
52 Linear guide
52A Rail
52B Guide unit
53, 54 Guide connection unit
55 Cable carrier
101 Leg robot
111A to 111F Leg
151 Arm robot
161 Rotation shaft
162 Expansion/contraction linear motion mechanism
163 Connection unit
164 Expansion/contraction linear motion mechanism
165 Gripper

1. A moving body comprising:
an expansion/contraction linear motion mechanism that expands and contracts in a first direction,
wherein the expansion/contraction linear motion mechanism includes
a first link,
a second link,
a plurality of sprockets that includes a drive sprocket arranged on the first link and that is arranged on a plane parallel to the first direction, and
a chain that connects the sprockets to each other, both ends of the chain being connected to the second link,
the first link and the second link at least partially overlap in a second direction perpendicular to the plane, and
as the drive sprocket is driven, the first link and the second link move in the first direction so as to approach or separate from each other.

2. The moving body according to claim 1,
wherein the expansion/contraction linear motion mechanism further includes
a third link,
at least a part of a plurality of the sprockets is arranged on the first link and the third link,
at least a part of the third link overlaps with the first link and the second link in the second direction, and
as the drive sprocket is driven, the first link and the third link move in the first direction so as to approach or separate from each other.

3. The moving body according to claim 2,
wherein, as for side surfaces of the second link, a first side surface and a second side surface parallel to the plane and opposed to each other, and a third side surface perpendicular to the first side surface and the second side surface and parallel to the first direction are arranged in a U shape, and
a part of the third link is sandwiched between the first side surface and the second side surface of the second link.

4. The moving body according to claim 3,
wherein the second link and the third link are at least partially housed in a space formed by the first link and a cover that covers a surface of the first link on which the sprocket is arranged.

5. The moving body according to claim 4,
wherein the first side surface of the second link is opposed to the first link, and
a cable carrier that houses a cable is arranged between the first link and the first side surface of the second link.

6. The moving body according to claim 5, further comprising:
a joint portion that is connected to the first link,
wherein the cable carrier houses cables that extend from the joint portion.

7. The moving body according to claim 3,
wherein a linear guide that guides movement of the second link in the first direction is arranged on a surface of the third link opposed to the third side surface of the second link.

8. The moving body according to claim 7,
wherein the linear guide has dustproof and waterproof specification.

9. The moving body according to claim 2,
wherein a portion where the chain is connected to the second link overlaps with the third link in the first direction.

10. The moving body according to claim 2,
wherein a linear guide that guides movement of the first link in the first direction is arranged on a first surface on the plane side and a second surface on a back side of the third link.

11. The moving body according to claim 10,
wherein the second surface of the third link is provided with a rib that is higher than an upper end of the linear guide.

12. The moving body according to claim 10,
wherein the linear guide has dustproof and waterproof specification.

13. The moving body according to claim 2,
wherein one end of the chain extends from the first link in a direction of the second link and is connected to the second link via a first spring, and
another end of the chain extends from the third link in a direction of the second link and is connected to the second link via a second spring.

14. The moving body according to claim 13,
wherein a maximum spring force of the first spring is equal to or higher than a maximum load generated at a connecting portion with the chain, and
a maximum spring force of the second spring is equal to or higher than a maximum load generated at a connecting portion with the chain.

15. The moving body according to claim 13,
wherein the expansion/contraction linear motion mechanism is used for a leg,
the first link is arranged at a base of the leg,
the second link is arranged at a tip end of the leg,
the third link is arranged between the base and the tip end of the leg, and
a spring constant of the second spring is higher than a spring constant of the first spring.

16. The moving body according to claim 1, further comprising:
a motor that drives the drive sprocket.

17. The moving body according to claim 16,
wherein the motor is a dustproof and waterproof specification planetary gear-equipped motor,
the drive sprocket is directly connected to an output shaft of the motor,
a passive sprocket of a plurality of the sprockets is supported by a bearing with a contact-type seal, and
the chain is a seal chain.

18. An expansion/contraction linear motion mechanism comprising:
a first link;
a second link;
a plurality of sprockets that includes a drive sprocket arranged on the first link and that is arranged on a plane parallel to a first direction; and
a chain that connects the sprockets to each other, both ends of the chain being connected to a first connecting portion of the second link,
wherein the first link and the second link at least partially overlap in a second direction perpendicular to the plane, and
as the drive sprocket is driven, the first link and the second link move in the first direction so as to approach or separate from each other.
